(19) United States
(12) Patent Application Publication
(10) Pub. No.: US 2021/0291353 A1
(43) Pub. Date: Sep. 23, 2021

(54) TOOL FOR OPERATING HANDLES AND BUTTONS TO PREVENT DIRECT HUMAN CONTACT

(71) Applicant: SmartCone Technologies Inc., Stittsville (CA)

(72) Inventors: Jacques Y. Guigné, Paradise (CA); Jason Lee, Arnprior (CA); Miles Hammond, Ottawa (CA)

(21) Appl. No.: 17/209,717

(22) Filed: Mar. 23, 2021

Related U.S. Application Data
(60) Provisional application No. 62/993,143, filed on Mar. 23, 2020.

(51) Int. Cl. B25J 1/04; B25J 19/00; B25J 18/00

(52) U.S. Cl. CPC B25J 1/04; B25J 18/00; B25J 19/00

(57) ABSTRACT

A tool for operating handles and buttons includes a tool body comprising a handle for insertion of human fingers. A first pushing surface is disposed at one end of the tool body, and a hook is formed in the tool body.

### CROSS REFERENCE TO RELATED APPLICATIONS

Priority is claimed from U.S. Provisional Application No. 62/993,143 filed on Mar. 23, 2020, which application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of tools to operate devices ordinarily operated by contact with parts of the human hand.

Spread of disease by microorganisms is frequently through contact of the human hand on surfaces that are contaminated with such microorganisms. When such surfaces are in places accessible and used by the public, sanitation of such surfaces after each use or contact is impracticable.

There is a need for apparatus to enable the public to use generally accessible devices in a way that reduces human contact with microorganism laden surfaces.

### SUMMARY

One aspect of the present disclosure is a tool for operating handles and buttons. A tool according to this aspect of the disclosure includes a tool body comprising a handle for insertion of human fingers. A first pushing surface is disposed at one end of the tool body, and a hook is formed in the tool body.

Some embodiments further comprise a second pushing surface opposed to the first pushing surface in the tool body, the second pushing surface having a smaller area than the first pushing surface.

Some embodiments further comprise a light disposed in the tool body.

Some embodiments further comprise a radio frequency tracking device disposed in the tool body.

In some embodiments, the tool body comprises antimicrobial plastic.

In some embodiments, the plastic comprises polymeric biocide.

### BRIEF DESCRIPTION OF THE DRAWINGS

FIGS. 1 through 4 show example devices ordinarily operated by parts of the human hand.

FIG. 5 shows a side view of an example embodiment of a tool according to the present disclosure.

FIG. 6 shows an oblique view of the embodiment shown in FIG. 5.

FIG. 7 shows an enlarged oblique view of the embodiment of FIG. 5 and FIG. 6.

FIG. 8 shows an end view of the embodiment in FIG. 5.

FIG. 9 shows a top view of the embodiment of FIG. 5.

### DETAILED DESCRIPTION

A tool according to the present disclosure is intended to enable a human user to operate various devices ordinarily operated by parts of the human hand. Such operation may facilitate spread of illnesses. By enabling operating such devices without direct contact of the human hand, spread of illness may be reduced or avoided.

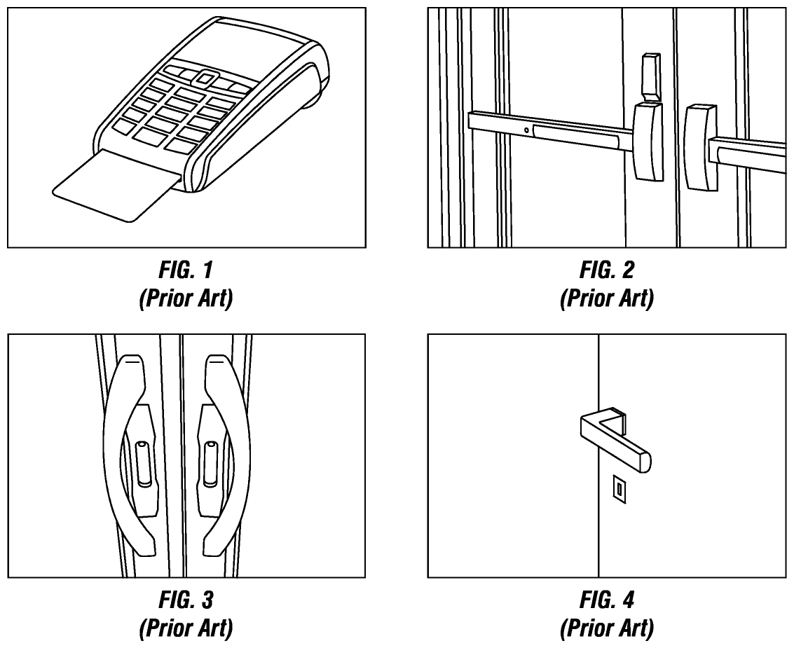

FIG. 1 shows an example embodiment of a credit card reader. If such a credit card reader is not affixed to a surface, it is subject to movement when, for example, a chip-based smart card or magnetic strip credit card is inserted into a card reader slot. A human user would ordinarily restrain movement of the card reader with use of his free hand. A tool according to the present disclosure may enable restraining the credit card reader without direct hand contact. Further, the credit card reader may require operating of certain buttons on a key pad to cause certain functions to take place. A tool according to the present disclosure may enable operating such key pad devices without contact by the human hand.

FIG. 2 shows example embodiments of doors having push-bar release operating mechanisms. Such mechanisms are ordinarily operated by a push with the human hand. A tool according to the present disclosure may enable operating such mechanisms without direct contact by the hand.

FIG. 3 shows an example embodiment of doors having pull handle operating mechanisms. Such mechanisms are ordinarily operated by a pull from fingers of the human hand wrapped around the pull handle. A tool according to the present disclosure may enable operating such mechanisms without direct contact by the hand.

FIG. 4 shows an example embodiment of a door having a rotatable latch mechanism. Such mechanisms are ordinarily operated by a twist with the human hand, generally by wrapping the fingers about the handle. A tool according to the present disclosure may enable operating such mechanisms without direct contact by the hand.

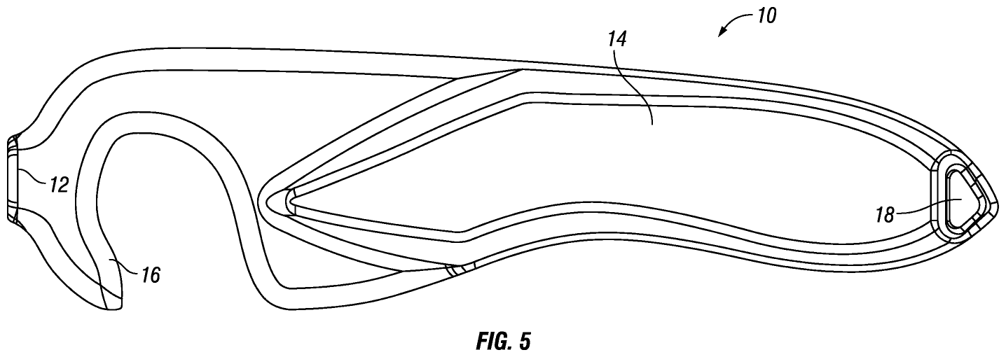

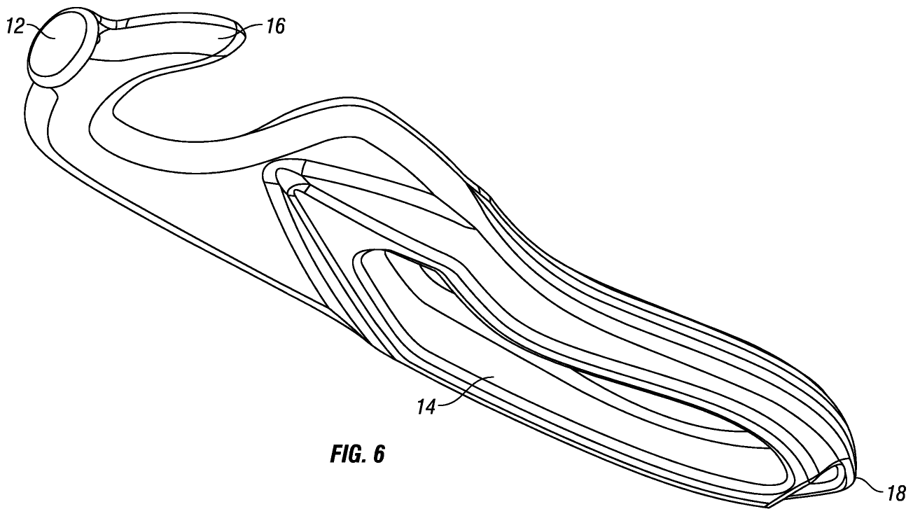

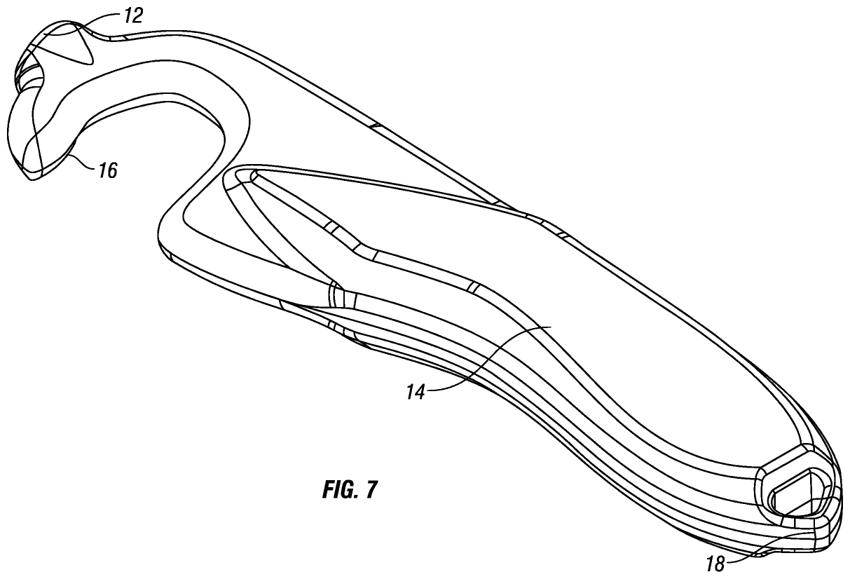

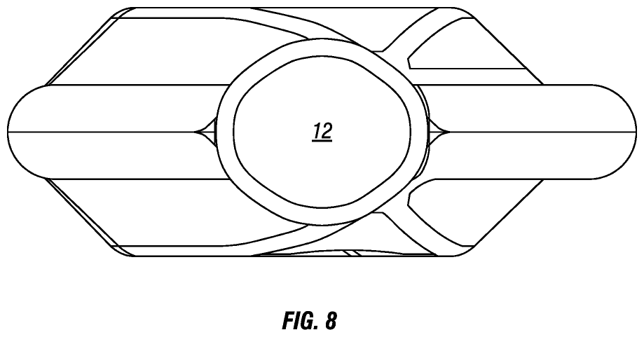

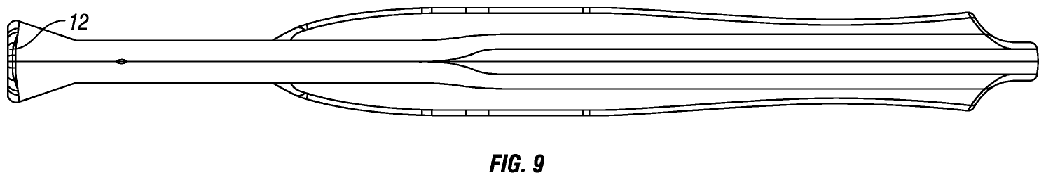

FIG. 5 shows one view of an example embodiment of a tool 10 according to the present disclosure. FIG. 6 shows an oblique view of the embodiment shown in FIG. 5. FIG. 7 shows an enlarged oblique view of the embodiment shown in FIG. 5 and FIG. 6. FIG. 8 shows an end view of the embodiment shown in FIG. 5. FIG. 9 shows a top view of the embodiment shown in FIG. 5. The various views shown in FIGS. 5 through 9 provide like reference numerals for the same illustrated elements.

The tool 10 may be formed from a solid, single piece of metal or plastic such as by casting, machining or injection molding. The tool 10 may comprise a handle 14 for insertion and wrapping of the human fingers. The tool 10 may comprise a pushing surface 12 at one end for operating push type devices, such as the door mechanisms shown in FIG. 2. The tool 16 may comprise a hook 16 formed at one end for engagement and operation of devices such as the door handles shown in FIGS. 3 and 4. The hook 16 may be used to restrain movement of devices such as the credit card reader show in FIG. 1.

The tool 10 may comprise a small pushing surface 18 which may be used, for example to operate key pad devices such as on the credit card reader in FIG. 1.

Some embodiments may comprise RFID or RF tracking devices (not shown) built into some part of the tool 10, such as the handle 14. A light (not shown) may be included in some embodiments.

In some embodiments, the tool 10 may be made from antimicrobial plastic. As used herein, antimicrobial plastic may comprise a synthetic polymer material containing an integrated active ingredient which makes it effective against microbial growth. Antimicrobial polymers, also known as polymeric biocides, are a class of polymers having some ability to inhibit growth of microorganisms such as bacteria, fungi or protozoans. Antimicrobial polymers have been designed to mimic antimicrobial peptides, which are used by immune systems of living things to kill bacteria. Antimicrobial polymers are produced by attaching or inserting an active antimicrobial agent onto a polymer backbone using an alkyl or acetyl linker. Antimicrobial polymers may enhance the efficiency and selectivity of certain known antimicrobial agents, while decreasing associated environmental hazards because antimicrobial polymers are generally nonvolatile and chemically stable.

A tool according to the present disclosure may enable persons to operate various devices without the need for direct contact of the hands with any part of the operated devices. Such operation may reduce transmission of disease by reason of microorganisms present on the surfaces of such devices.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A tool for operating handles and buttons, comprising:
a tool body comprising a handle for insertion of human fingers;
a first pushing surface at one end of the tool body; and
a hook formed in the tool body.

2. The tool of claim 1 further comprising a second pushing surface opposed to the first pushing surface in the tool body, the second pushing surface having a smaller area than the first pushing surface.

3. The tool of claim 1 further comprising a light disposed in the tool body.

4. The tool of claim 1 further comprising a radio frequency tracking device disposed in the tool body.

5. The tool of claim 1 wherein the tool body comprises antimicrobial plastic.

6. The tool of claim 6 wherein the plastic comprises polymeric biocide.
